(19) United States
(12) Patent Application Publication
(10) Pub. No.: US 2016/0165266 A1
(43) Pub. Date: Jun. 9, 2016

(54) SYSTEM AND METHOD FOR MOTION PICTURE EXPERT GROUP (MPEG) TRANSPORT STREAM SPLICING

(71) Applicant: International Datacasting Corporation, Kanata (CA)

(72) Inventors: Kirill Bocharnikov, Kanata (CA); Michael Heitner, Ontario (CA); Babak Shaikhvand, San Diego, CA (US)

(21) Appl. No.: 14/962,048

(22) Filed: Dec. 8, 2015

Related U.S. Application Data
(60) Provisional application No. 62/088,993, filed on Dec. 8, 2014.

(51) Int. Cl. H04N 21/234

(52) U.S. Cl. CPC H04N 21/234

(57) ABSTRACT

A system to splice new content into a live stream in a single frequency network. The system includes a program clock reference (PCR) adjustment module, an intelligent packet replacement module, and a rate adaptation module to match a stream rate associated with the live stream with a stream rate associated with the new content.

### CROSS-REFERENCE TO RELATED APPLICATIONS

This application claims priority to U.S. Provisional Application No. 62/088,993 filed Dec. 8, 2014, which is hereby incorporated by reference herein in its entirety.

### FIELD OF THE INVENTION

The present disclosure generally relates to digital media broadcasting and commercial insertion. More specifically it relates to the transmission and splicing of Motion Picture Expert Group transport streams.

### BACKGROUND OF THE INVENTION

MPEG transport streams or media streams have program clock references (PCRs) encoded in the data which contain data to allow a decoder to generate a system timing clock from the received transport stream. This is performed by the encoder to allow a decoder to display the media that these streams carry accurately. The PCRs are generated by an encoder, and are used in the decoding of the stream.

When new content is spliced into a live stream, the PCRs in the new content cause a discontinuity and therefore decoders are unable to decode the spliced content properly. One possible solution is to use hardware clocks to recover or “re-stamp” the PCRs within splicers but there are several problems with using hardware clocks.

However, since each hardware clock on each splicer unit is non-identical to the other, this process will never produce identical values at each splicer. This makes such an implementation incompatible for Single Frequency Networks (SFNs) which require “bit identical” content from all the transmitter units in a cluster so that a downstream receiver can correctly decode the information.

Secondly, using hardware clocks on each of the splicers require that the hardware clocks be highly accurate. This may increase overall splicer cost.

Additionally, the accuracy of the hardware clocks must be maintained. This will require that each hardware clock on each splicer be continuously updated and compensated for any drift.

Therefore, there is a requirement for solutions which are not dependent on the hardware clocks in the splicer.

### SUMMARY OF THE INVENTION

A first embodiment of the invention includes an apparatus to splice MPEG transport streams in a communications network. The apparatus comprises an input to receive a first transport stream where the first transport stream comprises a first clock marker. The apparatus also comprises a storage unit storing for storing a second transport stream where the second transport stream comprising a second clock marker. There is a reference clock adaptation module coupled to the input and the storage unit. The reference clock adaptation module receives the first transport stream from the input and the second transport stream from the storage unit. The reference clock adaptation module uses information contained in the first clock marker to adjust the second clock marker to produce an adjusted clock marker and replaces the second clock marker with the adjusted clock marker in the second transport stream to produce an adjusted transport stream. A splicing subsystem coupled to the rate adaptation module to splice the first transport stream together with the adjusted transport stream.

In some embodiments the apparatus also comprises a second input for receiving the second transport stream and storing it in the storage unit.

In other embodiments the apparatus adjusts the clock by calculating a difference between the first clock marker and the byte difference between the first clock marker and the second clock marker.

In a further embodiment the apparatus splices the first transport stream together with the adjusted transport stream by replacing part of the first transport stream with the adjusted transport stream.

An additional embodiment of the invention includes a method of adjusting stream rates of MPEG transport streams in a communications network that comprises receiving a first transport stream and a second transport stream. The first transport stream and the second transport stream comprising a plurality of clock reference data. A splice point is determined in the first transport stream and the splice point associated with a first clock reference data in the first transport stream. A second clock reference data in the second transport stream is replaced with the first clock reference data. A byte offset is calculated between the splice point and a third clock reference data in the second transport stream. The third clock reference data is located subsequent to the second clock reference data in the second transport stream. The third clock reference data is replaced with an adjusted third clock reference data where the adjusted third clock reference data based on the first clock reference data and the byte offset.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example embodiment of a Single Frequency Network.

FIG. 2A shows an example embodiment of a splicer.

FIG. 2B shows an example embodiment of a Programme Clock Reference (PCR) adjustment module.

FIG. 2C shows a flowchart of an example embodiment for splicing together live stream 101 and new content 102.

FIG. 3 shows an example embodiment of PCR adjustment.

FIG. 4 shows a second example embodiment of PCR adjusting.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

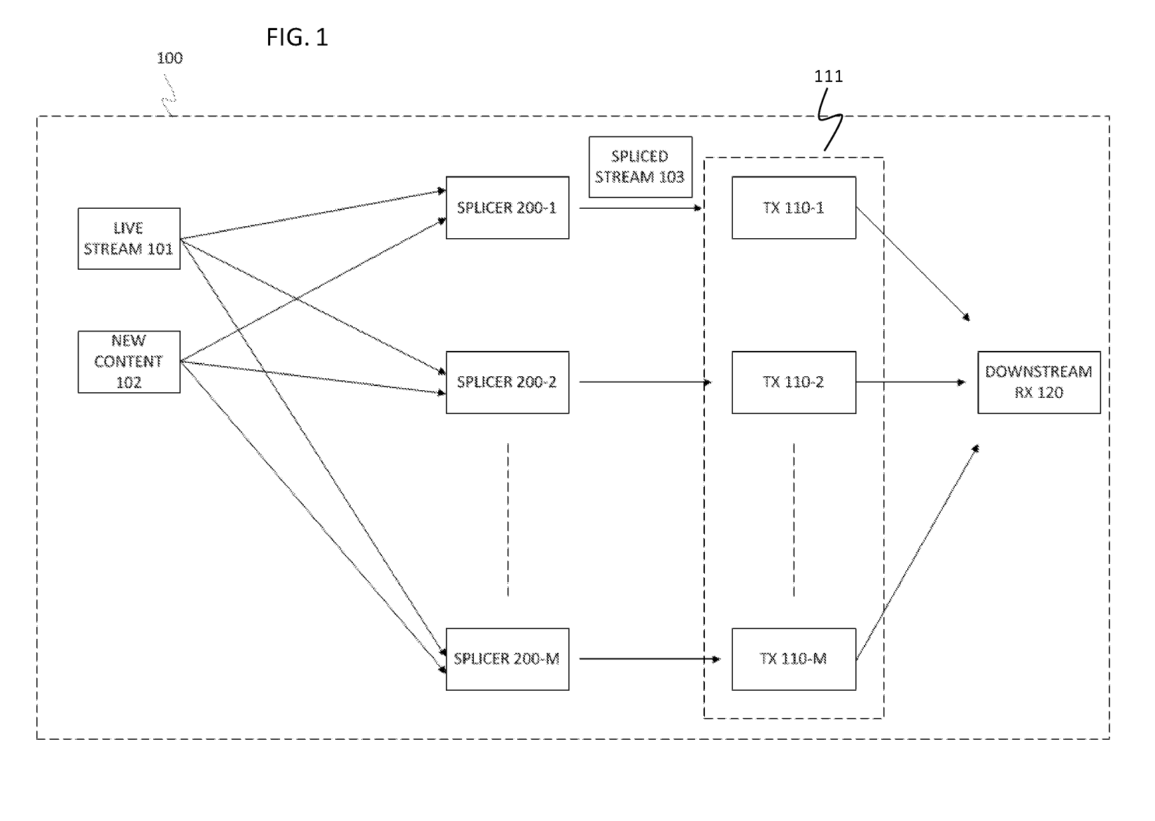

FIG. 1 shows an example arrangement for a Single Frequency Network (SFN). Content from a Motion Picture Expert Group (MPEG) live input stream 101 is fed to several transport stream splicers 200-1 to 200-M. At each splicer, live stream 101 is spliced with new content 102, and the output spliced stream 103 is sent to one of the transmitters 110-1 to 110-M in cluster 111. This output spliced stream 103 is transmitted; and received and decoded by a downstream receiver/decoder 120. The live stream 101 and new content 102 contain multiple types of packets, such as, for example, video and audio packets.

The new content 102 may be data stored locally on a hard drive within the splicer, or in remote storage, or a stream input into the splicer that is different from the live stream 101. While these examples have been presented, it is known to one of skill in the art that new content is not limited to only these examples of sources.

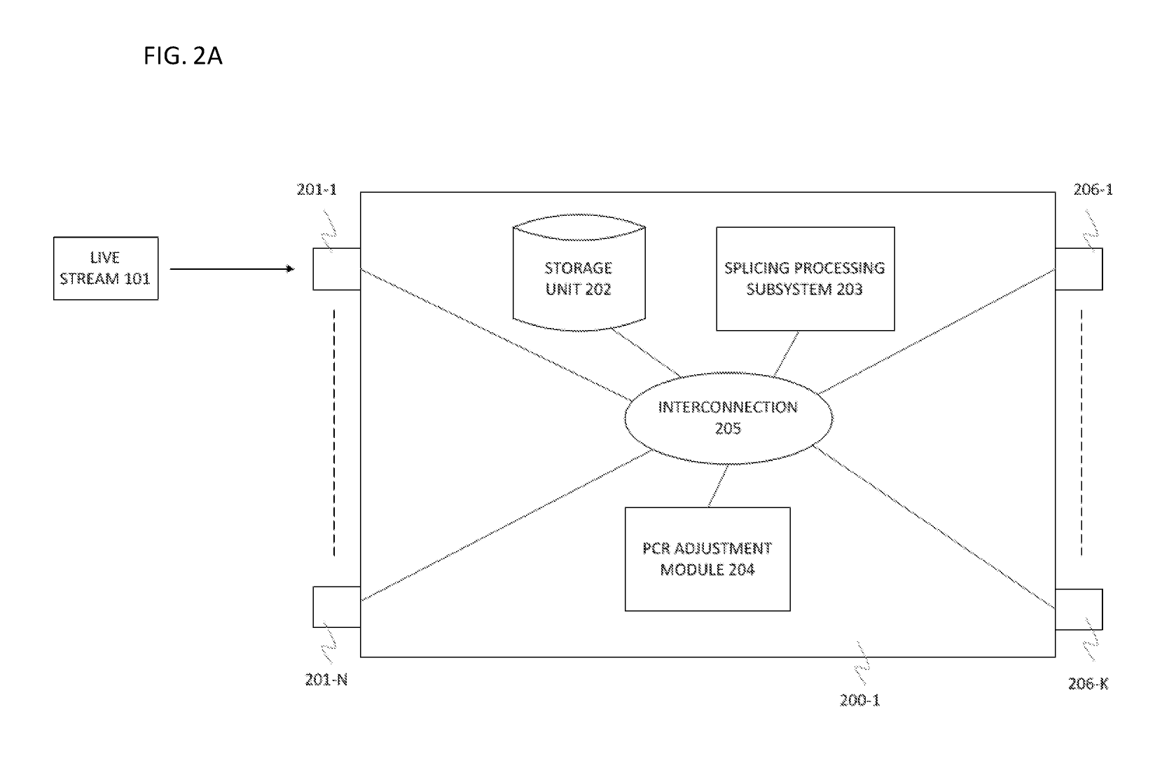

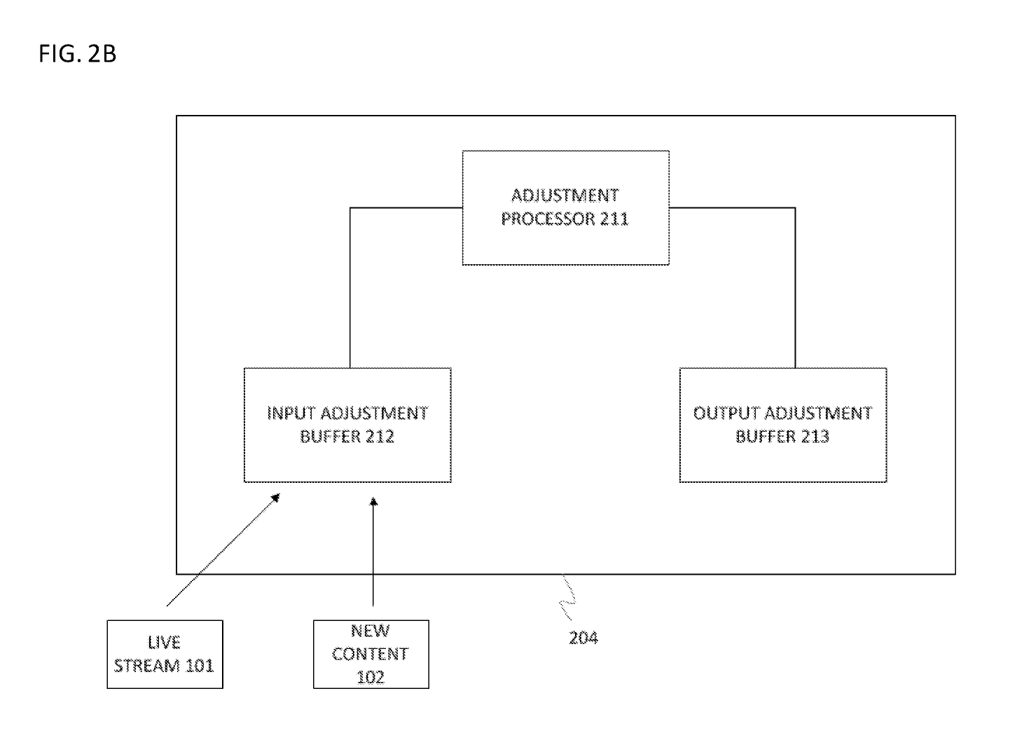

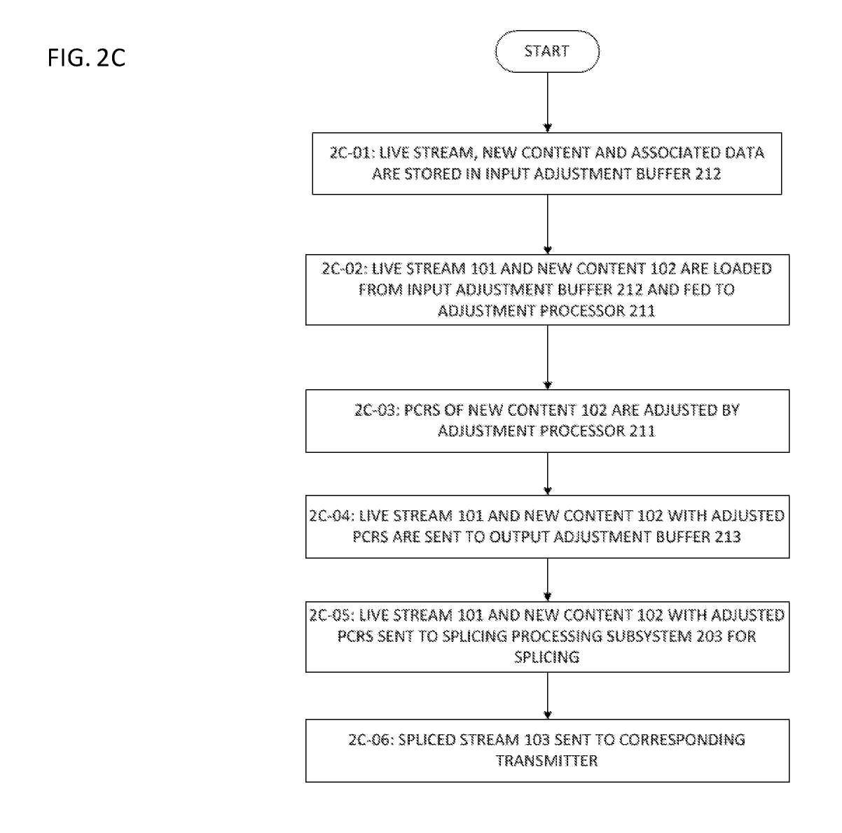

One embodiment of the invention describes a system and method to perform PCR adjustment. Referring to FIG. 2A, the system and method are implemented within a splicer 200-1. The splicer 200-1 comprises a storage unit 202, one or more inputs 201-1 to 201-N, one or more outputs 206-1 to 206-K, PCR adjustment module 204 and a splicing processing subsystem 203. Each of these components may be implemented using a combination of hardware and software. The splicer 200-1 may also be implemented using one or more servers with customized hardware and software.

These components are interconnected using interconnection 205. Interconnection 205 may include wired, wireless or optical media. In one embodiment, interconnection 205 is, for example, a local area network (LAN), a wide area network (WAN), or a campus area network (CAN). In another embodiment, interconnection 205 is created using one or more network technologies known to those of skill in the art, such as Bluetooth, Ethernet, TCP/IP and so on. In one embodiment, interconnection 205 encompasses one or more subnetworks.

The live stream 101 is fed into the splicer from a first input 201-1. The new content to be inserted into the live stream may be stored on storage unit 202, or be received from an input 201-2 to 201-N different from 201-1.

The PCR adjustment module 204 is shown in further detail in FIG. 2B. This module performs the PCR adjustment on the new content. The adjustment module comprises an adjustment processor 211, an input adjustment buffer 212, and an output adjustment buffer 213.

FIG. 2C shows a flowchart of an example embodiment for splicing together live stream 101 and new content 102. In step 2C-01 live stream 101; new content 102; and data associated with the live stream 101 and new content 102 comprising one or more unadjusted PCRs are initially stored in the input adjustment buffer 212 as shown in FIG. 2B.

Then, in step 2C-02, the live stream and new content are loaded from input adjustment buffer 212, and fed to the adjustment processor 211.

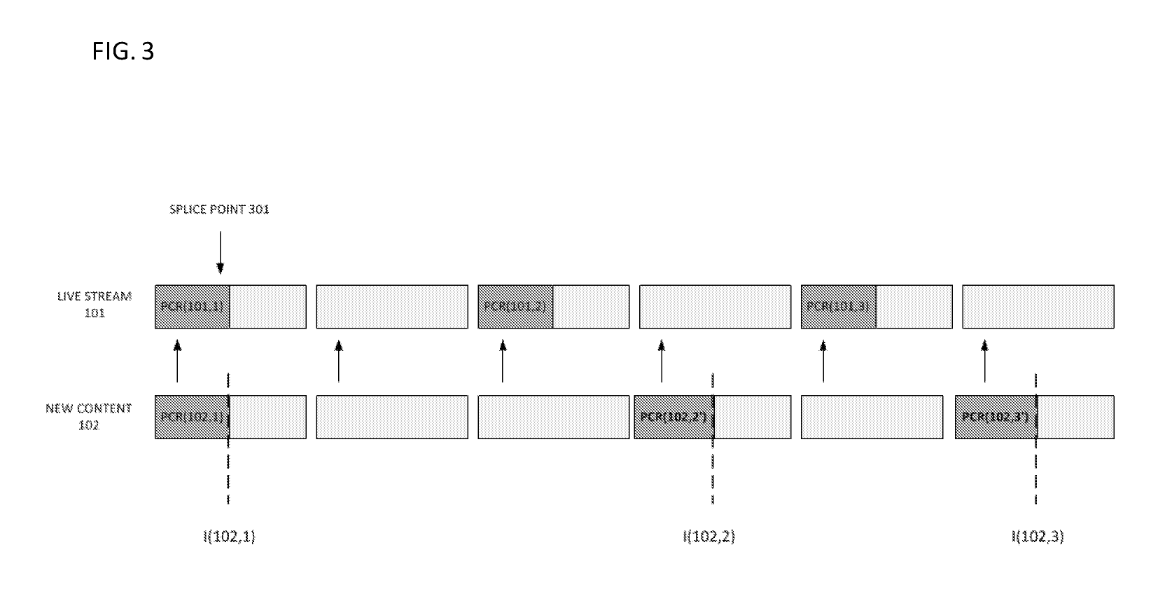

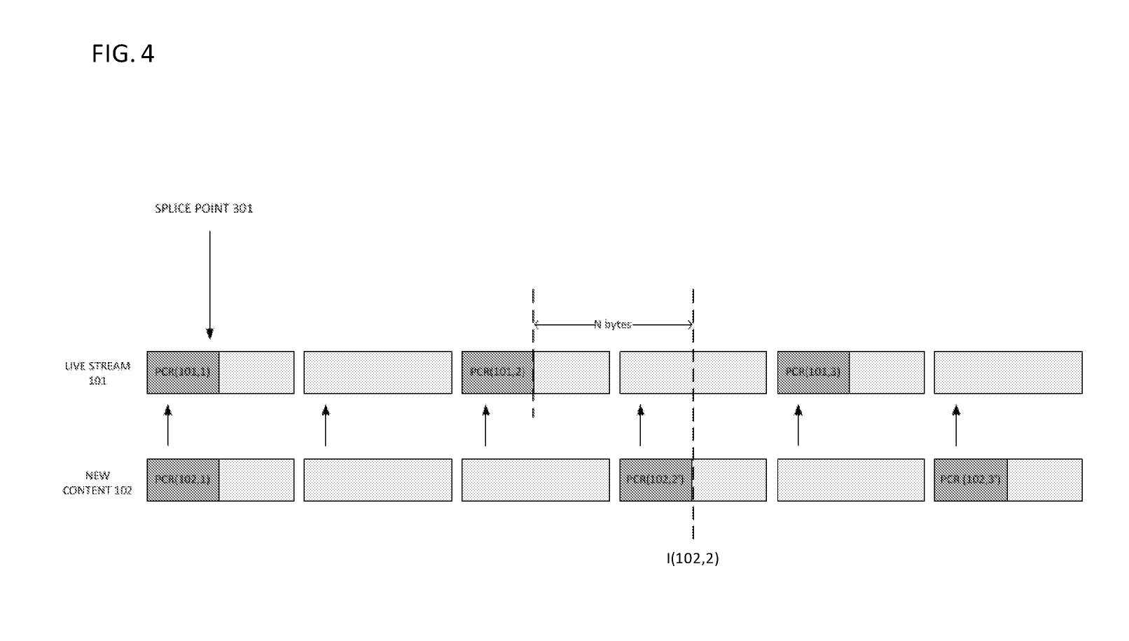

In step 2C-03, the unadjusted PCRs of the new content 102 are adjusted by the adjustment processor 211 as shown in FIGS. 3 and 4. This is performed using the following:
(1) First, the number of bytes between the PCR for the live stream 101 at the splice point 301, PCR(101,1) and the unadjusted second PCR for the new content PCR(102,2) to be spliced is calculated. As would be known to one of skill in the art, PCR(102,1) which is the first unadjusted PCR of the new content at the splice point, is replaced by PCR(101,1). Then, in one embodiment the number of bytes is obtained by subtracting the index for the byte containing the last bit of PCR(102,1) from the index for the byte containing the last bit of PCR(102,2).
(2) Next, since the transport rates of the live stream 101 and the new content 102 are the same and are constant, the PCR(102,2) is adjusted using the following formula, and with further reference to FIG. 3:

$$PCR ( 102 , {2}^{′} ) = PCR ( 101 , 1 ) + \frac{( {i}_{2} - {i}_{1} ) \times ( system clock frequency )}{transport rate}$$

where
   PCR (102,2′) is the adjusted version of PCR (102,2)
   PCR(101,1) is the PCR for the first stream at the splice point
   i₂ is I(102,2), the index for the byte containing the last bit of PCR(102,2)
   i₁ is I(102,1), the index for the byte containing the last bit of PCR (102,1)
(3) Subsequent PCRs to PCR(102,2) for the new content 102, as represented by PCR (102,n+1), must be adjusted. In one embodiment, these are calculated using the following formula, and with further reference to FIG. 3:

$$PCR ( 102 , n + {1}^{′} ) = PCR ( 102 , {n}^{′} ) + \frac{( {i}_{n + 1} - {i}_{n} ) \times ( system clock frequency )}{transport rate}$$

where
   n≧2
   PCR (102,n+1′) is the adjusted version of PCR (102,n+1)
   PCR(102,n′) is the adjusted version of PCR (102,n)
   iₙ₊₁ is I(102,n+1) is the index for the byte containing the last bit of PCR(102,n+1)
   iₙ is I(102,n) is the index for the byte containing the last bit of PCR (102,n)
(4) In a further embodiment, in order to remove compounding error in the calculation, a byte counter implemented by, for example, adjustment processor 211 is initialized to zero and started when a live stream PCR is received. Then, when a PCR is encountered in the new content 102, this PCR is adjusted using the last available live stream PCR in the live stream, using the formula:

$$PCR ( new ) = PCR ( last available ) + \frac{( byte counter ) \times ( system clock frequency )}{transport rate}$$

When a new live stream PCR is received, the last available PCR in the live stream is changed to this value, the byte counter is initialized to zero and restarted.
An example is shown in FIG. 4. PCR (101,2) is received and a byte counter is initialized. Then, when PCR (102,2) is received, the byte counter shows N bytes received. PCR (102,2′) is then calculated as:

$$PCR ( 102 , {2}^{′} ) = PCR ( 101 , 2 ) + \frac{N \times ( system clock frequency )}{transport rate}$$

The same calculation can be carried out for PCR(102,3′) except that this time the last available PCR would be PCR(101,3).

Once the PCR adjustment is complete, in step 2C-04 the live stream and the new content with the adjusted PCRs is then sent to output adjustment buffer 213.

In step 2C-05 these two streams are then sent on to splicing processing subsystem 203 of FIG. 2A, where the live stream 101 is then spliced with the new content 102 with the adjusted PCRs to form the spliced stream 103 shown in FIG. 1.

In step 2C-06, the spliced stream 103 is then sent on to a corresponding one of the transmitters 110-1 to 110-M via one of the outputs 206-1 to 206-K. This spliced stream is then transmitted by each of the transmitters 110-1 to 110-M. Performing the PCR adjustment described above enables correct receiving and decoding by a downstream receiver 120.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. An apparatus to splice MPEG transport streams in a communications network, the apparatus comprising:
an input to receive a first transport stream, the first transport stream comprising a first clock marker;
a storage unit storing therein a second transport stream, the second transport stream comprising a second clock marker;
a reference clock adaptation module coupled to the input and the storage unit, the reference clock adaptation module receiving the first transport stream from the input and the second transport stream from the storage unit, the reference clock adaptation module using information contained in the first clock marker to adjust the second clock marker to produce an adjusted clock marker and replacing the second clock marker with the adjusted clock marker in the second transport stream to produce an adjusted transport stream; and
a splicing subsystem coupled to the rate adaptation module to splice the first transport stream together with the adjusted transport stream.

2. The apparatus of claim 1, further comprising a second input, the second input for receiving the second transport stream and storing it in the storage unit.

3. The apparatus of claim 1, wherein the adjusting of the second clock comprises calculating a difference between the first clock marker and the byte difference between the first clock marker and the second clock marker.

4. The apparatus of claim 1, wherein the splicing of the first transport stream together with the adjusted transport stream comprises replacing part of the first transport stream with the adjusted transport stream.

5. A method of adjusting stream rates of MPEG transport streams in a communications network, the method comprising:
receiving a first transport stream and a second transport stream, the first transport stream and the second transport stream comprising a plurality of clock reference data;
determining a splice point in the first transport stream, the splice point associated with a first clock reference data in the first transport stream, and replacing a second clock reference data in the second transport stream with the first clock reference data;
calculating a byte offset between the splice point and a third clock reference data in the second transport stream, the third clock reference data being located subsequent to the second clock reference data in the second transport stream; and
replacing the third clock reference data with an adjusted third clock reference data, the adjusted third clock reference data based on the first clock reference data and the byte offset.

6. A method of splicing MPEG transport streams in a communications network, the method comprising:
receiving a first transport stream that includes a first clock marker;
storing a second transport stream that includes a second clock marker;
receiving said first transport stream and said second transport stream in a reference clock adaptation module that
uses information contained in the first clock marker to adjust the second clock marker to produce an adjusted clock marker, and
replaces the second clock marker with the adjusted clock marker in the second transport stream to produce an adjusted transport stream; and
splicing the first transport stream with the adjusted transport stream.

7. The method of claim 6, further comprising receiving the second transport stream and storing it in a storage unit.

8. The method of claim 6, wherein the adjusting of the second clock comprises calculating a difference between the first clock marker and the byte difference between the first clock marker and the second clock marker.

9. The method of claim 6, wherein the splicing of the first transport stream together with the adjusted transport stream comprises replacing part of the first transport stream with the adjusted transport stream.
